(19) United States
(12) Patent Application Publication
(10) Pub. No.: US 2026/0183726 A1
(43) Pub. Date: Jul. 2, 2026

(54) LIQUID DROPLET OR AIR BUBBLE GENERATION DEVICE, AND LIQUID DROPLET OR AIR BUBBLE GENERATION METHOD

(71) Applicant: FUJIFILM CORPORATION, Tokyo (JP)

(72) Inventors: Ryo MATSUNO, Kanagawa (JP); Taiki HOMMA, Kanagawa (JP)

(21) Appl. No.: 19/334,961

(22) Filed: Sep. 22, 2025

Related U.S. Application Data
(63) Continuation of application No. PCT/JP2024/012107, filed on Mar. 26, 2024.

(30) Foreign Application Priority Data
Mar. 30, 2023 (JP) 2023-056777

(51) Int. Cl. B01F 25/314; B01F 23/231; B01F 23/45; B01F 25/00

(52) U.S. Cl. CPC B01F 25/3141; B01F 23/2312; B01F 23/45; B01F 25/31421; B01F 25/31425; B01F 2025/913

(57) ABSTRACT

A liquid droplet or air bubble generation device according to the present disclosure includes a cylindrical tube having a plurality of pores on a wall surface, and a helical partition structure that is fixedly disposed inside the cylindrical tube and forms a helical flow channel in a longitudinal direction of the cylindrical tube, in which the helical flow channel makes two or more turns within the cylindrical tube.

### CROSS-REFERENCE TO RELATED APPLICATIONS

This application is a continuation of International Application No. PCT/JP2024/012107, filed on Mar. 26, 2024, which claims priority from Japanese Patent Application No. 2023-056777, filed on Mar. 30, 2023. The entire disclosure of each of the above applications is incorporated herein by reference.

### BACKGROUND OF THE INVENTION

### 1. Field of the Invention

The present disclosure relates to a generation device and a generation method for generating liquid droplets or air bubbles dispersed in a continuous phase.

### 2. Description of the Related Art

Techniques have been developed for mass-producing monodisperse liquid droplets for bioanalysis or industrial functional materials. In the direct membrane emulsification method used therein, liquid droplets are generated by a shearing force applied to the emulsified portion of the porous pipe membrane (more precisely, a shearing force of the continuous phase that tears off the substance emerging from the pores of the porous pipe membrane to form liquid droplets). However, in a case where the shearing force is weak, it is difficult to produce liquid droplets having a small particle diameter with respect to the pore diameter with good productivity. To increase the shearing force, it is considered to increase the flow rate of the entire continuous phase flowing in the porous pipe membrane. However, since the linear velocity of a liquid generally becomes lower in the vicinity of the wall surface of the pipe, the shearing force becomes weaker toward the wall surface from the center of the pipe. Therefore, there is an issue that even in a case where the flow rate of the entire continuous phase is increased, the shearing force applied to the wall surface is unlikely to be significantly increased. An insufficient shearing force causes coarsening of generated liquid droplets and reduces the productivity of monodisperse liquid droplets.

Furthermore, in the longitudinal direction of the porous pipe membrane, there is an issue that since the shearing force applied to the emulsified portion of the porous membrane is not uniform, the size distribution of the generated liquid droplets is large. The size of the liquid droplets varies depending on the application, but in many cases, it is preferable to keep the size distribution below a certain level.

As prior art for solving these issues, WO2012/133736A discloses a) an invention in which an inlet is designed and provided in a pipe to form a swirling flow of a continuous phase inside a pipe. JP2021-502249A discloses b) an invention in which an insert is inserted into a pipe, the clearance between the porous pipe membrane and the insert is reduced, thereby enabling an increase in linear velocity even at the same continuous phase flow rate.

### SUMMARY OF THE INVENTION

However, in the configuration disclosed in WO2012/133736A, a) the shearing force applied to the emulsified portion is partially improved, but the swirling force of the swirling flow gradually decreases in the longitudinal direction of the pipe, which causes an issue of insufficient shearing force or non-uniform shearing force at the downstream of the pipe. In addition, in the configuration disclosed in JP2021-502249A, b) by reducing the clearance, the shearing force per flow rate of the continuous phase increases, and the non-uniformity of the shearing force in the longitudinal direction of the pipe can be further reduced. However, there is an issue in that the clearance is narrow, liquid droplets are concentrated on the downstream side of the pipe, a collision frequency between the generated liquid droplets increases, and the liquid droplets coalesce. As described above, a device or a method for producing monodisperse liquid droplets with high productivity by simultaneously solving two issues of insufficient shearing force in the vicinity of the wall surface of the porous pipe membrane and non-uniform shearing force in the longitudinal direction of the porous pipe membrane has not been proposed.

The present disclosure has been made in view of the above circumstances. An object to be achieved by the present disclosure is to provide a liquid droplet or air bubble generation device that can produce monodisperse liquid droplets or air bubbles with high productivity by improving the insufficient shearing force applied to a wall surface of a continuous phase, eliminating non-uniformity of shearing forces between the upstream and downstream of the continuous phase, and further enabling the suppression of the coalescence of liquid droplets or air bubbles.

Specific means for solving the above objects include the following aspects.

<1>

A liquid droplet or air bubble generation device comprising:
a cylindrical tube having a plurality of pores on a wall surface; and
a helical partition structure that is fixedly disposed inside the cylindrical tube and forms a helical flow channel in a longitudinal direction of the cylindrical tube,
in which the helical flow channel makes two or more turns within the cylindrical tube.
   <2>

The liquid droplet or air bubble generation device according to <1>, in which the helical partition structure has a core rod that is concentric with the cylindrical tube.

<3>

The liquid droplet or air bubble generation device according to <1> or <2>, in which a space volume obtained by subtracting a volume of the helical partition structure from a space volume in the cylindrical tube is 10% or more and 80% or less of the space volume in the cylindrical tube.

<4>

The liquid droplet or air bubble generation device according to any one of <1> to <3>, in which a helical pitch of the helical partition structure varies along the longitudinal direction of the cylindrical tube.

<5>

The liquid droplet or air bubble generation device according to any one of <1> to <4>, in which a clearance between a maximum outer diameter of the helical partition structure and an inner diameter of the cylindrical tube is 0.5 mm or less.

<6>

The liquid droplet or air bubble generation device according to any one of <1> to <5>, in which the cylindrical tube is a porous glass body.

<7>

The liquid droplet or air bubble generation device according to any one of <1> to <5>, in which the cylindrical tube is a porous body in which the pores having a diameter of 0.1 μm to 200 μm are formed in a metal pipe.

<8>

The liquid droplet or air bubble generation method using the liquid droplet or air bubble generation device according any one of <1> to <7>, the generation method comprising:
in a case where a liquid or a gas passes through the plurality of pores and enters the cylindrical tube, generating liquid droplets or air bubbles of the liquid or the gas that has entered the cylindrical tube, by a shearing force of a continuous phase flowing through the helical flow channel in the cylindrical tube.

According to the present disclosure, the liquid droplet or air bubble generation device has the helical partition structure that is fixedly disposed in the cylindrical tube, whereby it is possible to improve the insufficient shearing force in the vicinity of the wall surface of the continuous phase and to eliminate the non-uniformity of the shearing force in the upstream and downstream of the continuous phase at the same time. Furthermore, since the clearance of the space in which the liquid droplets or the air bubbles are generated can be ensured, the liquid droplets or the air bubbles can be suppressed from coalescing. Therefore, according to the liquid droplet or air bubble generation device of the present disclosure, it is possible to obtain liquid droplets or air bubbles with high productivity and high quality.

### BRIEF DESCRIPTION OF THE DRAWINGS

FIG. 1 is a schematic cross-sectional view of a liquid droplet or air bubble generation device 10 according to an embodiment.

FIG. 2A is a diagram illustrating an example of a screw body.

FIG. 2B is a diagram illustrating an example of a method of fixing the screw body.

FIG. 3 is a diagram illustrating an example of a swirling flow that swirls in a longitudinal direction.

FIG. 4 is a diagram showing the uniformity of a shearing force in a longitudinal direction.

FIG. 5A is a diagram illustrating an example of a change in a helical pitch of a screw body.

FIG. 5B is a diagram illustrating an example of a change in a thickness of a core rod of the screw body.

FIG. 6 is a diagram illustrating an example of the use of the liquid droplet or air bubble generation device.

FIG. 7 is a diagram illustrating a configuration during PIV imaging.

FIG. 8 is a set of photographs of fluorescent particles taken in the upstream and downstream regions.

FIG. 9 is a graph showing productivity and production efficiency in a case where a screw body is inserted.

FIG. 10A is a histogram of particle diameters of Comparative Examples 3 and 4.

FIG. 10B is a histogram of particle diameters of Examples 3 and 4.

FIG. 11A is a photograph of a particle diameter of Comparative Example 3.

FIG. 11B is a photograph of a particle diameter of Comparative Example 4.

FIG. 12A is a photograph of a particle diameter of Example 3.

FIG. 12B is a photograph of a particle diameter of Example 4.

FIG. 13 is a table showing the average particle diameter, the CV value, and the representative image of the liquid droplets generated in a case where the flow rate of the oil phase was 100 ml/min.

### DESCRIPTION OF THE PREFERRED EMBODIMENTS

Hereinafter, embodiments of the liquid droplet or air bubble generation device of the present disclosure will be described in detail. The description provided below may be based on representative embodiments of the present disclosure, but the present disclosure is not limited to such embodiments. Within the scope of the purpose of the present disclosure, modifications can be made as appropriate.

In the present disclosure, a numerical range expressed using “to” means a range including numerical values before and after “to” as a lower limit value and an upper limit value.

In a numerical range described in a stepwise manner in the present disclosure, an upper limit or a lower limit described in a certain numerical range may be replaced with an upper limit or a lower limit in another numerical range described in a stepwise manner. In addition, in the numerical ranges described in the present disclosure, an upper limit value and a lower limit value disclosed in a certain range of numerical values may be replaced with values shown in Examples.

In addition, in each drawing, the same or corresponding parts are denoted by the same or similar reference numerals, and the overlapping description will be omitted.

### [Liquid Droplet or Air Bubble Generation Device]

The liquid droplet or air bubble generation device of the present disclosure includes a cylindrical tube having a plurality of pores through which a liquid or a gas passes on a wall surface, and a helical partition structure that is fixedly disposed inside the cylindrical tube and forms a helical flow channel for a continuous phase in a longitudinal direction of the cylindrical tube. Furthermore, the helical partition structure is formed such that the helical flow channel makes two or more turns within the cylindrical tube. The cylindrical tube is a member having a cavity inside and having a plurality of pores through which a liquid or a gas passes from the outside toward the inside, on a wall surface thereof. The helical partition structure is a member that is fixedly disposed in the cylindrical tube and has a structure that forms a helical flow channel.

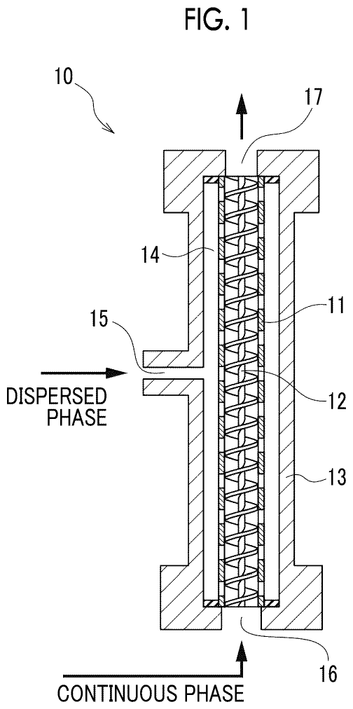

A liquid droplet or air bubble generation device 10, which is an embodiment of the liquid droplet or air bubble generation device according to the present disclosure, will be described with reference to FIG. 1. FIG. 1 is a simplified cross-sectional view of a liquid droplet or air bubble generation device 10. As shown in FIG. 1, a liquid droplet or air bubble generation device 10 includes a porous body 11 as a cylindrical tube, having pores, a screw body 12 as a helical partition structure, disposed within the porous body 11, and a housing 13 as a structure, surrounding the porous body 11. The entire outer periphery of the porous body 11 is surrounded by the housing 13 at predetermined distance such that a space 14 is formed between the outer surface of the porous body 11 and the inner surface of the housing 13. A liquid or gas that is a dispersed phase is introduced into the space 14. Therefore, the housing 13 has the dispersed phase introduction port 15 for introducing a liquid or a gas into the space 14 at at least one location on the outer surface thereof. Furthermore, the housing 13 has a continuous phase introduction port 16 for introducing a liquid that is a continuous phase. The continuous phase introduction port 16 is configured to communicate with the inside of the porous body 11 surrounded by the housing 13. In this way, the continuous phase introduced from the continuous phase introduction port 16 flows in the longitudinal direction within the porous body 11 and is led out from the discharge port 17 formed in the housing 13, which communicates with the inside of the porous body 11 on the downstream side.

### [Porous Body 11]

The porous body 11 as a cylindrical tube is a member having a cavity inside, and may be a member having a plurality of pores on a wall surface thereof for allowing a liquid or a gas to pass therethrough from the outside toward the inside to form liquid droplets or air bubbles. For example, the porous body 11 may be a porous body in which pores having a diameter of 0.1 μm to 200 μm are processed by a laser in a metal pipe such as SUS. Alternatively, the porous body 11 may be a porous glass body. Examples of the porous glass body include a shirasu porous glass (SPG) membrane. The SPG membrane can be purchased from, for example, SPG Technology Co., Ltd. Alternatively, the porous body 11 may be another porous membrane. As described above, the porous body 11 may be a porous body having a large number of fine through-holes through which a liquid or a gas passes from the outside toward the inside.

As a material of the porous body 11, a known material such as glass, ceramic, steel use stainless (SUS), or nickel can be used. The diameter of the pores of the porous body 11 may be appropriately selected according to the particle diameter of the desired dispersed phase. For example, in a case of generating liquid droplets or air bubbles of the order of microns, the pore diameter may be appropriately selected from a range of 0.1 μm to 200 μm. It goes without saying that the pore diameter may be selected from a range other than 0.1 μm to 200 μm. The number of pores is not particularly limited and may be appropriately selected from the dimensions (the inner diameter, the length in the longitudinal direction, the surface area, and the like) of the porous body as a cylindrical tube.

The shape of the porous body 11 is not particularly limited, but it is preferable that the inner diameter of the porous body 11 is constant in the longitudinal direction. In addition, the length of the porous body 11 in the longitudinal direction is not particularly limited as long as the porous body can be produced and functions as a porous body. Typically, the length is in a range of 10 mm to 500 mm. Other dimensions may be, for example, an inner diameter of 5 mm to 15 mm and a thickness of 0.1 mm to 1 mm.

Alternatively, the inner diameter of the porous body 11 may not be constant and, for example, may be configured to increase or decrease in the longitudinal direction.

The flow rate of the continuous phase flowing in the porous body 11 is not particularly limited, but is preferably in a range in which turbulence is not generated from the viewpoint of producing high-quality liquid droplets or air bubbles. As an example, in a case where the inner diameter of the porous body is 10 mm, the inner diameter corresponds to a Reynolds number of 4,000 or less, preferably 3,500 or less, and more preferably 3,000 or less.

### [Screw Body 12]

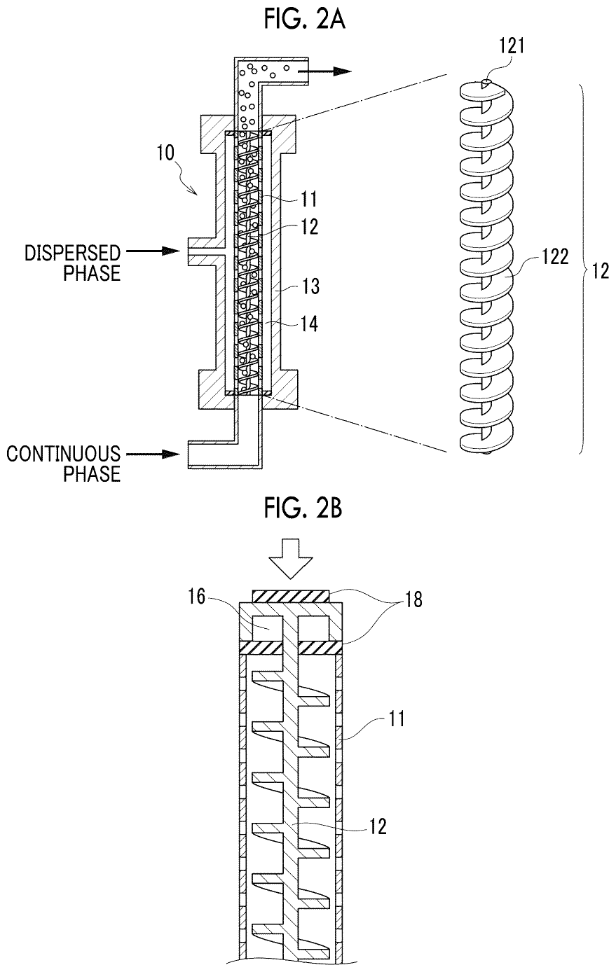

The screw body 12 as the helical partition structure is a member that is disposed within the porous body 11 and forms a helical flow channel. For example, the screw body 12 as shown in FIG. 2A may be used. The screw body 12 includes a solid core rod 121 that is concentric with the porous body 11, and a screw blade 122 that is formed to be wound around the core rod 121 in the longitudinal direction. In this way, the screw body 12 is fixedly disposed not to move in the porous body 11 (that is, to maintain non-swirling without rotation). For example, as shown in FIG. 2B, a packing such as rubber may be pressed in a direction of an arrow during device assembly and fixed not to move in the porous body 11. The winding direction of the screw blade is not particularly limited. The winding direction may be right-handed or left-handed. The term “concentric” is not limited to a case where the central axis of the cylindrical tube and the central axis of the core rod of the helical partition structure coincide with each other, and includes a case where the central axis of the cylindrical tube and the central axis of the core rod of the helical partition structure deviate from each other as long as the helical partition structure exhibits the effect of the present invention.

The material of the screw body 12 is not particularly limited. For example, the screw body 12 may be made of a resin or SUS. The screw body 12 may be processed by a 3D printer, may be processed by cutting, may be manufactured by casting, or may be manufactured by a combination thereof, using these materials. The length of the screw body 12 is not particularly limited as long as the effect of internally inserting the screw body can be sufficiently obtained. The length may be appropriately changed in accordance with the porous body 11. Typically, in a case where the inner diameter of the porous body 11 is 10 mm, the maximum inner diameter is 500 mm.

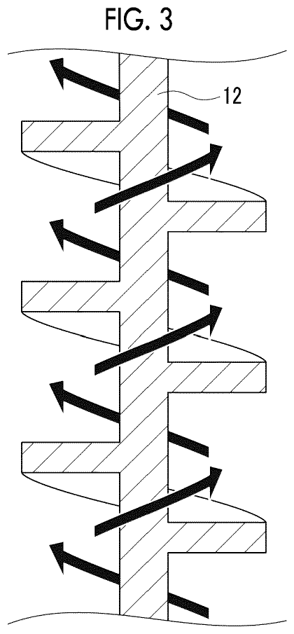

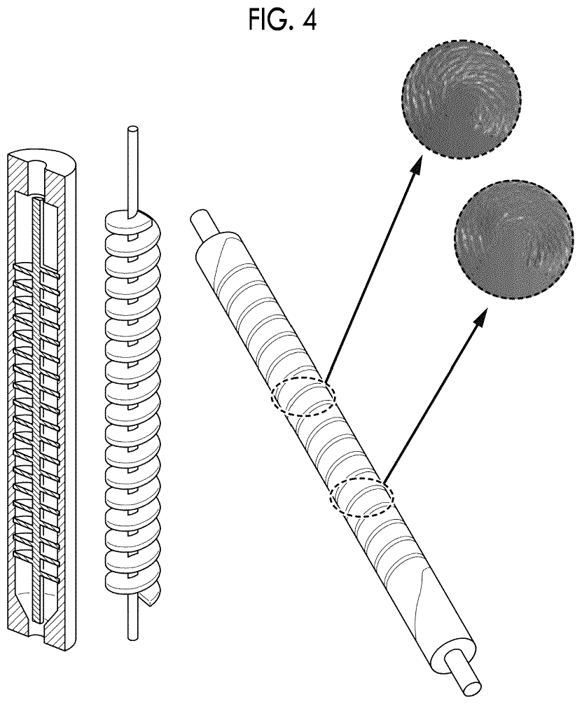

By disposing the screw body 12 inside the porous body 11, a helical flow channel is formed in the longitudinal direction within the porous body 11. Therefore, the continuous phase introduced into the porous body 11 flows within the porous body 11 while being swirled through the helical flow channel. Since the continuous phase flowing through the helical flow channel flows in the direction of the arrow shown in FIG. 3, the shearing force in the vicinity of the wall surface of the porous body 11 is improved. FIG. 4 is data showing the uniformity of the shearing force in the longitudinal direction. In the circle, a cross-sectional vector diagram showing the swirling flow at two different positions in the longitudinal direction is shown. As the continuous phase flows in the direction of the arrow shown in FIG. 3, the flow velocity in the longitudinal direction in the porous body 11 is uniform, the swirling is not attenuated as shown in FIG. 4, and the non-uniformity of the shearing force at the position in the longitudinal direction in the porous body 11 can be eliminated. Furthermore, since the structure is formed in the screw body shape, it is possible to secure the clearance between the wall surface of the porous body 11 and the screw body 12. That is, since the swirling flow is generated by the helical flow channel, the volume of the space can be increased while maintaining a high shearing force applied to the surface of the porous body 11, as compared with the case where the solid cylinder is inserted. Therefore, it is possible to suppress the coalescence of the generated liquid droplets or air bubbles. Details of these effects will be described in Examples. The “shearing force” refers to a force due to an inertial force caused by a continuous phase fluid, which is generated in a direction parallel to the surface of the porous body 11 (or the cylindrical tube) at the pore outlet on the surface of the porous body 11 (or the cylindrical tube).

It is preferable that the helical flow channel formed by the screw body 12 makes two or more turns within the porous body 11. The screw body 12 swirls more preferably 3 times or more and particularly preferably 4 times or more. Therefore, the screw blade 122 is formed on the core rod 121 to make at least two turns, preferably at least three turns, and more preferably four turns around the core rod 121. In a case where the configuration is adopted, since the continuous phase flows in the porous body 11 while repeatedly swirling along the wall surface, the shearing force due to the continuous phase can be increased in the vicinity of the wall surface of the porous body.

The dimensions of the screw body 12 can be appropriately selected according to the inner diameter of the porous body 11 and the particle diameter of the liquid droplets or the air bubbles to be generated. For example, in a case where the inner diameter of the porous body 11 is 8 mm and particles having a diameter of 200 μm are desired to be obtained, the helical outer diameter of the screw body 12 may be set to 7 mm to 8 mm, and the core rod diameter may be set to 5 mm to 6 mm. In this way, it is preferable to design the porous body in accordance with the dimensions of the porous body to be used and the particle diameter of the liquid droplets or the air bubbles to be generated.

Here, the “helical outer diameter” of the screw body is the maximum distance between both ends of the screw blade passing through the center of the core rod. In addition, the “helical pitch” is a distance between a screw blade positioned on a line parallel to the core rod and a screw blade adjacent to the screw blade. The “helical thickness” is the thickness of the screw blade itself.

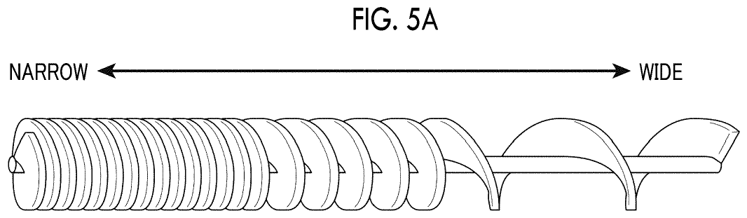

In a case where the design parameters of the screw body 12 are adjusted, the diameter of the liquid droplets or air bubbles to be generated can be more precisely adjusted. For example, as shown in FIG. 5A, in a case where the helical pitch of the screw body is narrowed, the flow velocity of the continuous phase is increased, and the shearing force of the continuous phase can be increased. On the contrary, in a case where the helical pitch is widened, the flow velocity of the continuous phase is reduced, and the shearing force of the continuous phase can be reduced. The range of the helical pitch is preferably 1 mm to 20 mm and more preferably 2 mm to 10 mm. In addition, as shown in FIG. 5B, in a case where the core rod diameter of the screw body is thinned, the clearance between the porous body 11 and the screw body 12 is widened, and as a result, the flow velocity of the continuous phase is slowed down, and the shearing force of the continuous phase can be reduced. In a case where the core rod diameter of the screw body is thickened, the clearance between the porous body 11 and the screw body 12 is narrowed, and as a result, the flow velocity of the continuous phase is increased, and the shearing force of the continuous phase can be increased. The range of the helical thickness is preferably 0.1 mm to 5 mm and more preferably 0.3 mm to 2 mm. As described above, the diameter of the liquid droplets or the air bubbles can be adjusted more finely by the design of the screw body 12. It is noted that the reduction in the shearing force generates particles having a larger diameter. On the contrary, the increase in the shearing force generates particles having a smaller diameter. Furthermore, it is preferable that a clearance (or a gap) between a maximum outer diameter of the screw blade 122 of the screw body 12 and an inner diameter of the porous body 11 is 0.5 mm or less. The clearance is more preferably 0.4 mm or less. In a case where the clearance is 0.5 mm or less, a shearing force applied to the wall surface of the continuous phase flowing through the helical flow channel can be sufficiently obtained.

As described above, the helical pitch of the screw body may be uniform in the entire screw body in accordance with the design of the screw body, may be different between the upstream and the downstream of the screw body, or may be gradually widened or narrowed from the upstream to the downstream. In addition, the core rod diameter of the screw body may be the same for the entire screw body in accordance with the design of the screw body, may be different upstream and downstream of the screw body, or may be gradually thickened or thinned from upstream to downstream. By widening the helical pitch or thinning the core rod diameter stepwise in the longitudinal direction, it is possible to substantially equalize the swirling velocity in response to the increase in total flow rate caused by the generated liquid droplets or air bubbles (that is, dispersed phases) downstream, thereby making the shearing force on the surface of the porous body more uniform. It is noted that the term “stepwise” may be either continuous or intermittent.

The volume of the screw body 12 in the space volume in the porous body 11 varies depending on the design of the screw body 12. In a case where the volume of the screw body 12 is determined, the space volume of the helical flow channel formed in the porous body 11 is determined. It is preferable that the space volume obtained by removing the volume of the screw body 12 from the space volume in the porous body 11 is 10% or more and 80% or less of the total space volume in the porous body 11. The space volume is preferably 10% or more and 60% or less. In a case where the space volume is 10% or more, it is possible to secure a clearance for the generated liquid droplets or air bubbles, and it is possible to suppress the liquid droplets or air bubbles from colliding with each other and coalescing. In a case where the space volume is 80% or less, the space inside the porous body 11 is limited, and a shearing force of the continuous phase flowing through the helical flow channel can be sufficiently obtained. It is noted that the space volume obtained by removing the volume of the screw body 12 from the space volume in the porous body 11 is equal to or substantially equal to the space volume of the helical flow channel.

### [Housing 13]

The housing 13 as a structure is a member that surrounds the porous body 11 and forms the space 14 shown in FIG. 1 together with the outer surface of the porous body 11. The configuration and shape of the housing 13 are not particularly limited, and the housing 13 may have a structure in which a liquid or gas that forms liquid droplets or air bubbles can be maintained outside the porous body 11 or a liquid or gas can be supplied to the pores of the porous body 11. Preferably, the structure is such that the inflow pressure of the dispersed phase applied to the porous body 11 is uniform. For example, the housing 13 may have a shape symmetrical with the porous body 11 on the same axis. As an example, the housing 13 may be configured such that a portion surrounding the porous body 11 has a coaxial double cylindrical shape with the porous body 11. Alternatively, the housing 13 may be configured such that the inner surface of at least a portion surrounding the porous body 11 has a coaxial double cylindrical shape with the porous body 11. In addition, a distance (or a gap) between the outer surface of the porous body 11 and the inner surface (that is, the side surface) of the housing 13 is preferably at least 1 mm. It is noted that the housing 13 has a dispersed phase introduction port 15 for introducing a liquid or a gas into the space 14 on an outer surface thereof. The dispersed phase introduction port 15 may be formed at one location, two locations, or a plurality of locations of more than two locations. Furthermore, the housing 13 has a continuous phase introduction port 16 for introducing a liquid that is a continuous phase and a discharge port 17 for discharging the continuous phase.

The material of the housing 13 is not particularly limited. However, it is preferable that the material has resistance to an acid, an alkali, or an organic solvent. Examples of the material include SUS.

### [Dispersed Phase/Continuous Phase]

The liquid or gas as the dispersed phase is not particularly limited. The liquid that serves as the continuous phase is also not particularly limited. For example, in a case of generating an emulsion of oil-in-water, the oil phase may be set as a dispersed phase and the water phase may be set as a continuous phase. In a case of generating an emulsion of water-in-oil, the oil phase may be a continuous phase and the water phase may be a dispersed phase. The oil phase may contain two or more oils or may contain components other than oils, depending on the use application. The water phase may contain a component other than water depending on the use application. Examples thereof include a surfactant and a viscosity adjuster. Depending on the selection of the material, a solid or gel can be formed at the interface between the dispersed phase and the continuous phase to form a capsule.

The particle diameter of the dispersed phase may be, for example, 10 μm to 500 μm or 50 μm to 300 μm. However, the present invention is not limited to these ranges. The particle diameter may be appropriately selected in accordance with the material to be selected.

In a case of generating air bubbles, compressed air (or pressurized air), hydrogen, oxygen, nitrogen, a rare gas, carbon dioxide, ozone, or the like is introduced as a gas. By introducing a gas, fine air bubbles can be obtained in the continuous phase. For example, fine bubbles (for example, bubbles having a diameter of 100 μm or less) can be obtained. It is noted that a surfactant or the like may be added to the continuous phase side to maintain the generated air bubbles for a longer period of time.

### [Liquid Droplet or Air Bubble Generation Method]

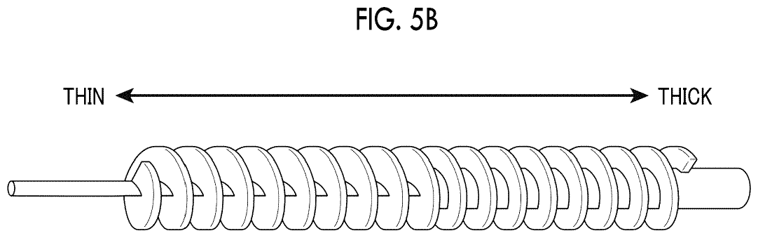

An example of a method of generating liquid droplets or air bubbles using a liquid droplet or air bubble generation device 10 (hereinafter, referred to as a generation device 10) will be described with reference to FIG. 6 and FIG. 1 as appropriate. It is noted that in the following, a case of generating liquid droplets will be described, but the same method is applied to a case of generating air bubbles. First, a liquid for forming liquid droplets is stored in a dispersed phase tank 20 that stores a liquid as a dispersed phase. In a case where the pressurized gas is introduced into the dispersed phase tank 20, the stored liquid is pressed into the generation device 10. The method of press-feeding the liquid is not particularly limited, and can be performed by a generally used method. The liquid is sent to the space 14 in the generation device 10 by press-feeding, and further passes through the pores of the porous body 11 and enters the inside of the porous body 11. On the other hand, the liquid that is the continuous phase stored in the continuous phase container 40, is sent into the inside of the porous body 11 of the generation device 10 by the circulation pump 50. The liquid sent into the porous body 11 flows through the helical flow channel formed by the screw body 12 and advances in the porous body 11 along the wall surface of the porous body 11 while swirling. At this case, the liquid that has passed through the pores of the porous body 11 and has entered the porous body 11 forms particles in a manner of being torn off by the shearing force of the swirling continuous phase, and floats in the continuous phase as a dispersed phase. The particles are discharged together with the continuous phase out of the porous body 11 and the generation device 10. In a case of using the generation method according to the present disclosure, it is possible to mass-produce particles having a uniform particle diameter on the order of microns. It is noted that FIG. 6 shows an embodiment in which the generated liquid droplets are sent to the continuous phase container 40 and circulate again with the continuous phase. However, the embodiment of the liquid droplet or air bubble generation device 10 is not limited thereto. For example, an embodiment in which the circulation line 41 is not provided in FIG. 6 and the generated liquid droplets are collected without being circulated may be used.

A digital pressure gauge 30 may be installed in a flow channel of the pressurized gas introduced into the dispersed phase tank 20 to control the pressure of the pressurized gas. In addition, as the pressurized gas, air or an inert gas such as nitrogen or a rare gas can be used.

As described above, in the liquid droplet or air bubble generation device according to the present disclosure, the screw body as the helical partition structure is disposed inside the porous body to form the helical flow channel, whereby the shearing force applied to the porous body wall surface that generates the liquid droplets or the air bubbles can be increased even at the same flow rate. Therefore, it is possible to reduce the size of the liquid droplets, to achieve monodispersion, and to achieve concentration (that is, to improve the ratio of the dispersed phase in the entire liquid).

Furthermore, the helical flow channel can be formed by inserting a screw body into the inside of the porous body, but the size, monodispersity, and concentration of the liquid droplets or the air bubbles can also be adjusted by changing the design parameters of the screw body. The design parameters include “clearance between a maximum outer diameter of a screw body and an inner diameter of a porous body”, “helical pitch”, “core rod diameter”, and the like, and by adjusting these, a shearing force applied to an inner wall of the porous body, a space volume for a helical flow channel, and the like can be adjusted, and as a result, physical properties of liquid droplets or air bubbles can be adjusted. For example, the shearing force changes depending on the helical pitch. As the helical pitch becomes narrower, a shearing force is applied, and the shearing force can be increased even at the same flow rate. In addition, since the core rod is provided, the flow channel can be narrowed and the flow velocity can be increased. As described above, in a case where the core rod is thickened, the shearing force is applied more. The “maximum outer diameter of the screw body” is an outer diameter of the screw body in a direction perpendicular to the longitudinal direction of the porous body.

Furthermore, as the flow proceeds to the downstream side, the flow rate of the dispersed phase is added (that is, the dispersed phase flows in from the outside of the porous body), whereby the total flow rate also increases as the flow proceeds to the downstream side. In the present disclosure, by changing the design parameters of the screw body from the upstream to the downstream (for example, by increasing the helical pitch toward the downstream), it is possible to more precisely equalize the shearing force applied to the inner wall of the porous body from the upstream to the downstream.

Furthermore, since the screw body is simply inserted and fixed, there is no need to increase the manufacturing cost. In addition, decomposition cleaning can be performed even after use. Therefore, there are few concerns about hygiene and quality. It is noted that the screw body can also be fixed to the porous body by baking and fitting, or the like. In a case where the screw body is integrated by baking and fitting, or the like, as in a case where the clearance is narrow, a sufficient shearing force can be obtained, and there are advantages such as no labor for attachment and detachment and high reproducibility of installation.

Currently, there is an increasing need for mass production of uniform liquid droplets, capsules, particles, and the like for industrial use, and the liquid droplet or air bubble generation device according to the present disclosure can provide liquid droplets or air bubbles with low cost, high quality, and high productivity for various needs.

### EXAMPLES

Hereinafter, the present invention will be described in detail with reference to examples, but the present invention is not limited to the following examples, within a range not departing the gist thereof.

### [Flow Visualization Experiment]

In a case where pure water containing fluorescent particles was allowed to flow into a cylindrical container having a screw body as a helical partition structure, and in a case where a swirling flow of pure water containing fluorescent particles was introduced into a cylindrical container having no screw body, the swirling properties of the fluorescent particles in the longitudinal direction of the cylindrical container were evaluated.

Production of Cylindrical Container with Insertable Screw Body/Cylindrical Container without Insertable Screw Body

A transparent cylindrical tube having an inner diameter of 10 mmφ and a length of 125 mm was produced using an acrylic pipe (acrylic pipe having outer diameter of 12 mmφ and wall thickness of 1 mm, manufactured by KOKUGO Co., Ltd.), a 3D printer XFAB2500 (manufactured by DWS S.R.L.), and a resin material Vitra 430 (clear). In both cases, the inner diameter of the liquid inlet was 2 mmφ, and the liquid inlet was formed at a position where the maximum outer diameter was inscribed within the inner diameter of 10 mmφ container. The dimensions of the screw body of the cylindrical container with insertable screw body were set to a helical pitch of 5 mm, a helical thickness of 1 mm, a core rod diameter of 2 mmφ, and a length of 40 mm and 90 mm.

### PIV Imaging

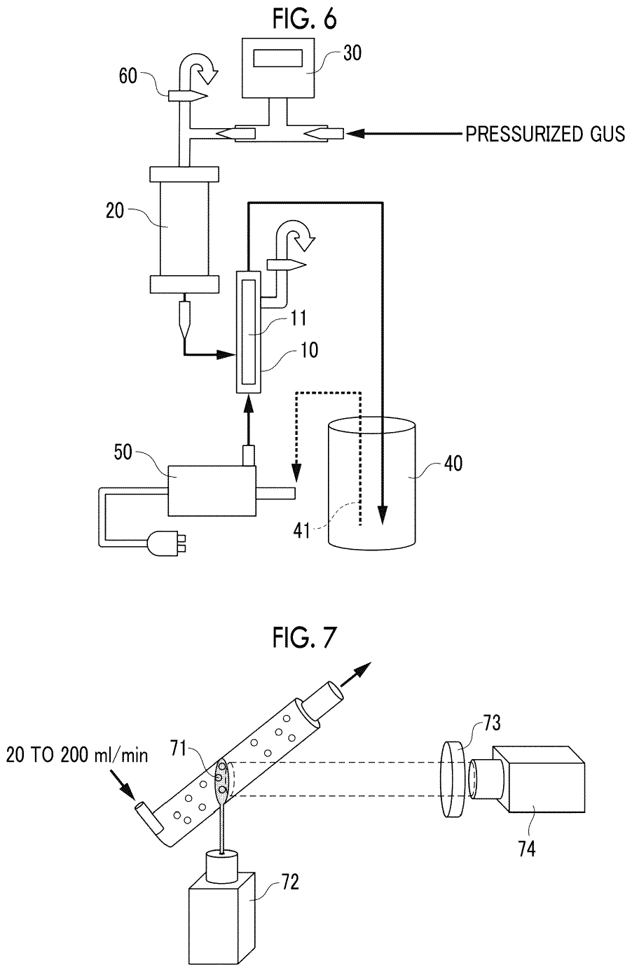

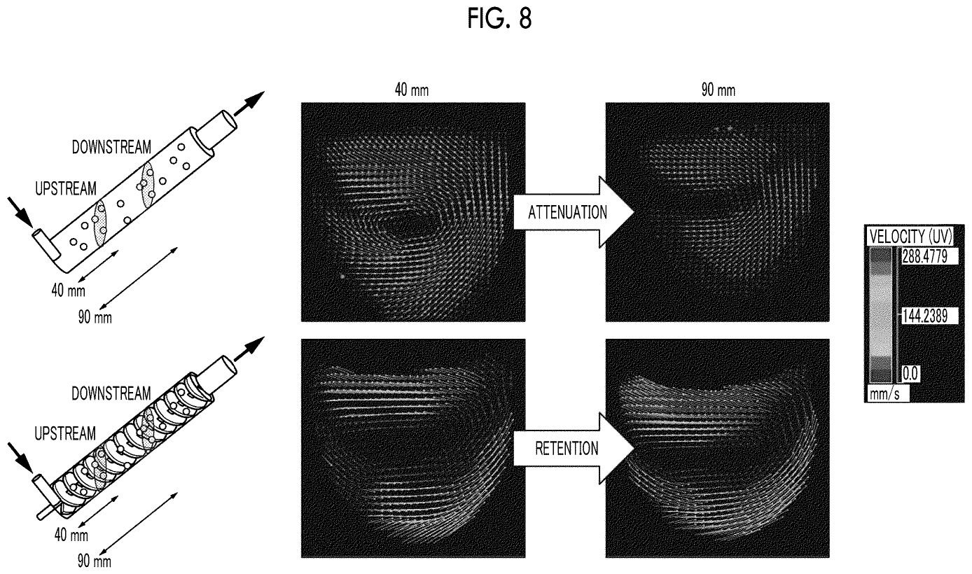

As shown in FIG. 7, pure water to which 0.01% of fluorescent particles 71 (Fluoro-Max R0300, manufactured by Thermo Fisher Scientific Inc.) having an emission wavelength of 612 nm when excited at 542 nm was allowed to flow into the cylindrical container with insertable screw body and the cylindrical container without insertable screw body at a flow rate of 200 ml/min. At this time, each cylindrical container was inclined by 45°. In the measurement of particle image velocimetry (PIV), a sheet laser light source 72 (PIV Laser KLD-G1, manufactured by Kato Optics Co., Ltd.) having a wavelength of 525 nm, a wavelength cut filter 73 (Y52 manufactured by Kenko Tokina Co., Ltd.), and a high-speed camera 74 (K5, manufactured by Kato Optics Co., Ltd.) were used. As shown in FIG. 8, the flowing fluorescent particles were imaged by irradiating the flowing fluorescent particles with a sheet laser at each of positions of 40 mm and 90 mm from the inlet for 1 second at 1,000 frames per second (fps) with a high-speed camera 74, and images the flowing fluorescent particles were converted into a velocity vector using analysis software FlowExpert64 (manufactured by Kato Engineering Co., Ltd.).

### Result

FIG. 8 shows photographs of fluorescent particles taken upstream (40 mm) and downstream (90 mm). The photographs actually taken are color photographs, and the color of the photographs represents the speed of the fluorescent particles. In any of the cylindrical containers, it was confirmed that a swirling flow occurred at a position (40 mm) upstream. However, it was confirmed that in the cylindrical container with insertable screw body, the flow velocity is higher in the outer peripheral portion (that is, the vicinity of the wall surface) of the cylindrical container than in the cylindrical container without insertable screw body, and a stronger wall surface shearing force is generated even at the same flow rate.

In addition, in a case of comparing a difference between the upstream (40 mm) and the downstream (90 mm) in the longitudinal direction of the cylindrical container, in the cylindrical container without insertable screw body, the swirling flow is significantly weakened downstream (that is, a change in the color of the particles is observed). However, in the cylindrical container with insertable screw body, it was confirmed that there was no difference in the flow state, the flow velocity, and the vector between the upstream and the downstream (that is, no change in the color of the particles was observed).

As a result, it was confirmed that, by inserting the screw body and forming a helical flow channel inside the cylindrical container, a strong swirling flow and a shearing flow on the wall surface, which are independent of the longitudinal position of the cylindrical container, can be generated.

### [Effect on Liquid Droplet Generation Properties]

In Examples and Comparative Examples, the generation properties of liquid droplets based on the difference in the insert installed in the porous cylindrical tube was evaluated.

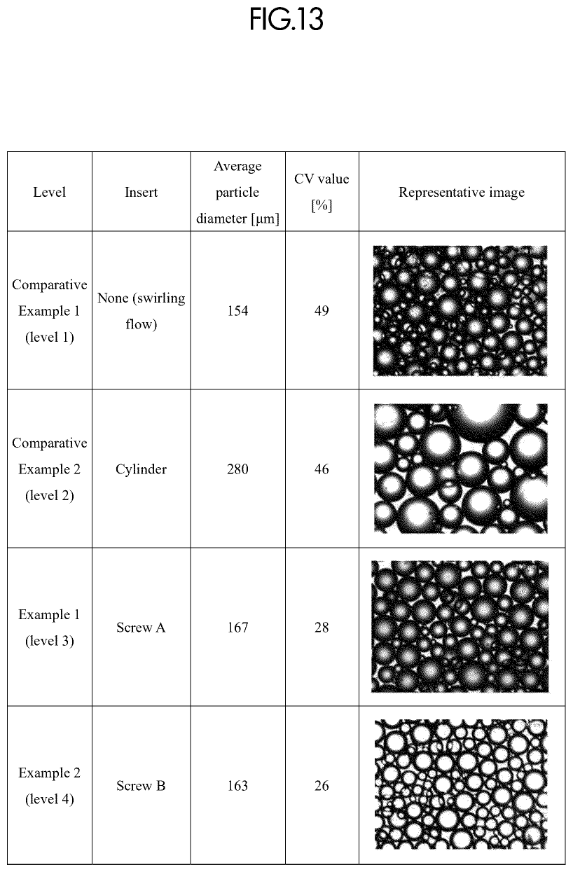

As the porous cylindrical tube, a thin SUS (thickness of 0.2 mm) cylindrical tube (custom-made) having an inner diameter of 9.6 mm was used, in which 120 pores of 50 μmφ were formed by laser processing. A part (insert in FIG. 13) to be inserted into the porous cylindrical tube was modeled using a 3D printer XFAB2500 (manufactured by DWS S.R.L.) and a resin material Vitra430 (clear) such that the insertion length was 125 mm. The following are the dimensions of each of the inserts.
Comparative Example 1: none
Comparative Example 2: cylinder, outer diameter of 9.2 mmφ (clearance with porous cylindrical tube: 0.2 mm)
* Protrusions of 0.2 mm were provided at six positions on the outer surface of the cylinder, and the cylinder was designed and manufactured to be positioned at the center of the porous cylindrical tube.
Example 1: screw A, core rod diameter of 2 mmφ, helical outer diameter of 9.4 mmφ, helical pitch of 5 mm, and helical thickness of 1 mm
Example 2: screw B, core rod diameter of 6 mmφ, helical outer diameter of 9.4 mmφ, helical pitch of 5 mm, and helical thickness of 1 mm
* In a case where the insert was inserted into the porous cylindrical tube, the insert was fixed with a rubber packing and a device (MD10L125, manufactured by SPG Techno Co., Ltd.) such that the insert was not driven by the flow of the liquid.

A porous cylindrical tube (and an insert) was fixed to the same device, and an oil phase was flowed in the outside of the porous cylindrical tube as a dispersed phase, and a water phase was allowed to flow into the inside thereof as a continuous phase, each at a flow rate set by each pump.
Oil phase: methyl laurate (manufactured by FUJIFILM Wako Pure Chemical Corporation)
Water phase: pure water in which 1% of polysorbate 20 (manufactured by FUJIFILM Wako Pure Chemical Corporation) is dissolved
Oil phase pump: Microfeeder JP-H, manufactured by Sanyo Technos Co., Ltd.
Water phase pump: HYSA-16P manufactured by FUJITECHNO KOGYO CO., LTD.

In the following four configurations, the flow rate of the oil phase was fixed at 10 ml/min, and the flow rate of the water phase was increased from 100 ml/min by 100 ml/min, and the minimum flow rate of the water phase at which the average particle diameter (the measurement method and the calculation method will be described later) of the generated liquid droplets was 150 μmφ±50 μm was obtained.
Comparative Example 1 (level 1): no insert, swirl introduction inlet
Comparative Example 2 (level 2): cylinder insertion, non-swirl introduction inlet
Example 1 (level 3): screw A insertion, non-swirl introduction inlet
Example 2 (level 4): screw B insertion, non-swirl introduction inlet

In each of the above-described configurations, the proportion of the flow channel to the space volume of the porous cylindrical tube is 100% in Comparative Example 1, 8.2% in Comparative Example 2, 77% in Example 1, and 49% in Example 2.

The minimum flow rates of the water phase were 1,000 ml/min in Comparative Example 1, 600 ml/min in Comparative Example 2, 600 ml/min in Example 1, and 400 ml/min in Example 2.

From this result, it was confirmed that in Example 1 and Example 2 in which the screw body was inserted and the helical flow channel was formed, the shearing force required for generating liquid droplets could be generated at a low flow rate. In addition, it was also confirmed that the shearing force can be adjusted by changing the shape of the screw body (changing the inner core diameter in Examples 1 and 2).

Next, the flow rate of the oil phase was increased by 20 ml/min while the flow rate of the water phase was fixed at the minimum, and the average particle diameter and the dispersity (CV value) of the generated liquid droplets were compared.

FIG. 13 shows the average particle diameter, the CV value, and the representative image of the liquid droplets generated in a case where the flow rate of the oil phase was 100 ml/min.

In Comparative Example 1, the number of liquid droplets having a small particle diameter was large, and the CV value was large. In Comparative Example 2, liquid droplets having a large particle diameter were generated by coalescence. In Examples 1 and 2, it was confirmed that liquid droplets having an extremely large or small particle diameter were not generated, and the size was uniform as compared with Comparative Examples. From this result, it was confirmed that, by inserting the screw body and forming the helical flow channel, liquid droplets having the same average particle diameter can be uniformly generated even from a low flow rate of the oil phase to a high flow rate of the oil phase, as compared with the methods disclosed in WO2012/133736A and JP2021-502249A.

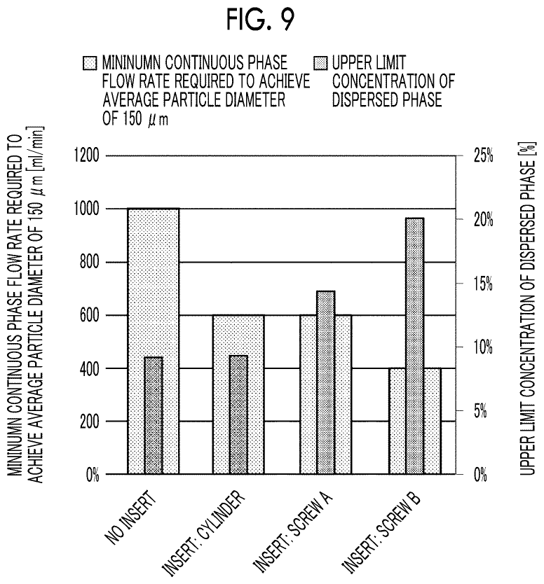

In addition, in the above-described work, the experiment was terminated at a point where the average particle diameter deviated from 150 μm±50 μm in each configuration, and the maximum flow rate of the oil phase (the upper limit flow rate of the oil phase) that did not deviate from this range was recorded. The upper limit concentration of the oil phase of each configuration was determined by dividing the flow rate of the oil phase by the minimum flow rate of the water phase. The values are shown in Table 1. Furthermore, a comparison between the minimum flow rate of the water phase (the minimum flow rate of the continuous phase) and the upper limit concentration of the oil phase (the upper limit concentration of the dispersed phase) is shown in the graph of FIG. 9.

$$Expression : upper limit concentration of oil phase ( \% ) = upper limit flow rate of oil phase / ( flow rate of water phase + upper limit flow rate of oil phase ) \times 100$$

TABLE 1

| | | Flow rate | Upper limit | Upper limit |
|---|---|---|---|---|
| | | of water | flow rate of oil | concentration |
| | Insert | phase [ml/min] | phase [ml/min] | of oil phase [%] |
| Comparative | None | 1,000 | 100 | 9% |
| Example 1 | (swirling flow) | | | |
| Comparative | Cylinder | 600 | 80 | 12% |
| Example 2 | | | | |
| Example 1 | Screw A | 600 | 100 | 14% |
| Example 2 | Screw B | 400 | 100 | 20% |

The graph of FIG. 9 shows that the upper limit concentration of the dispersed phase is high even though the minimum flow rate of the continuous phase is low in Examples 1 and 2. From this result, it was confirmed that the productivity and the production efficiency of the liquid droplets are significantly improved by inserting the screw body and forming the helical flow channel, as compared with the methods disclosed in WO2012/133736A and JP2021-502249A.

[Verification of Liquid Droplet Generation Uniformity from Upstream to Downstream]

The generation properties of liquid droplets was evaluated in Examples and Comparative Examples based on the presence or absence of a screw body in the pipe-shaped SPG membrane and the difference in the effective area of the SPG membrane.

A pipe-shaped SPG membrane (10 mmφ, pore diameter of 20 μm, hydrophilic, manufactured by SPG Techno Co., Ltd.) was used as the porous cylindrical tube. In addition, the screw insert was produced by cutting and processing (custom-made) SUS304 to have a helical outer diameter of 8.2 mm, a core rod diameter of 2 mmφ, a helical pitch of 5 mm, and a helical thickness of 1 mm, in accordance with the actual inner diameter (8.4 mm) of the used pipe-shaped SPG membrane, and fixed using the same device (MD10L125, manufactured by SPG Techno Co., Ltd.) as described above. The effective area of the SPG membrane was 100 mm in length.

The oil phase was allowed to flow into the outside of the pipe-shaped SPG membrane as a dispersed phase, and the water phase was allowed to flow into the inside thereof as a continuous phase, each at a flow rate set by each pump. In the comparative example without screw insertion, a swirling flow of the water phase was introduced.
Oil phase: methyl laurate (manufactured by FUJIFILM Wako Pure Chemical Corporation)
Water phase: pure water in which 1% of polysorbate 20 (manufactured by FUJIFILM Wako Pure Chemical Corporation) is dissolved
Oil phase pump: Microfeeder JP-H, manufactured by Sanyo Technos Co., Ltd.
Water phase pump: HYSA-16P manufactured by FUJITECHNO KOGYO CO., LTD.

During the generation of the liquid droplets, in each configuration, the upstream region of the water phase of 33 mm was left, and the sealing tape (fluorine sealing tape, manufactured by AS ONE Corporation) was wound on the outer side of the downstream side to adjust the generation of the liquid droplets. The flow rate was adjusted for each configuration, and the flow rate shown in Table 2 was set for each configuration. In the configuration using the upstream region of 33 mm, in a case where the flow rate of the oil phase was fixed at 100 ml/min, the flow rate was set such that an average particle diameter was 50 μm±5 μm.

TABLE 2

| | | SPG membrane | Flow rate of | Flow rate of |
|---|---|---|---|---|
| | Screw | usage region | water phase | oil phase |
| | insertion | [mm] | [ml/min] | [ml/min] |
| Comparative | Absent | 33 | 1,000 | 33 |
| Example 3 | | | | |
| Comparative | Absent | 100 | 1,000 | 100 |
| Example 4 | | | | |
| Example 3 | Present | 33 | 600 | 33 |
| Example 4 | Present | 100 | 600 | 100 |

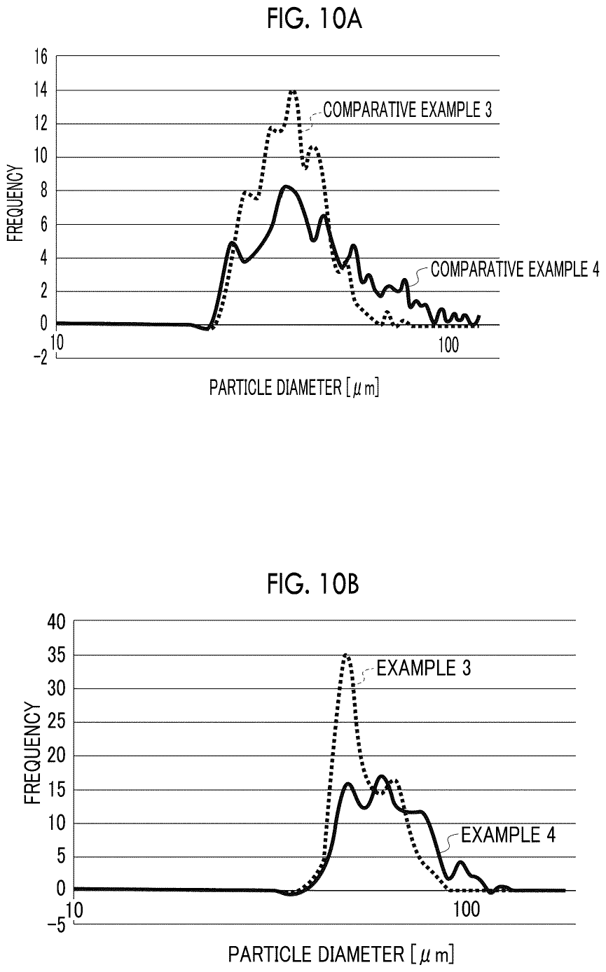

Table 3 shows the average particle diameter and the CV value of the liquid droplets generated in each configuration. Histograms of particle diameters are shown in FIGS. 10A and 10B.

TABLE 3

| | Average particle | |
|---|---|---|
| | diameter [μm] | CV value [%] |
| Comparative | 51 | 23 |
| Example 3 | | |
| Comparative | 62 | 36 |
| Example 4 | | |
| Example 3 | 50 | 17 |
| Example 4 | 58 | 23 |

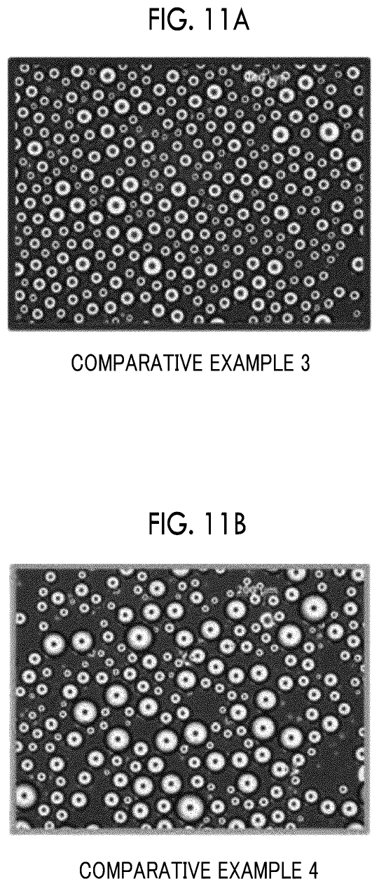

From the above results, in the method disclosed in WO2012/133736A, in a case where only the upstream region of the pipe-shaped SPG membrane as the porous cylindrical tube was used (Comparative Example 3) and in a case where the entire region was used (Comparative Example 4), as shown in FIGS. 11A and 11B, the number of liquid droplets having a large particle diameter was increased in a case where the entire region was used, and the CV value was deteriorated to 36% in Comparative Example 4.

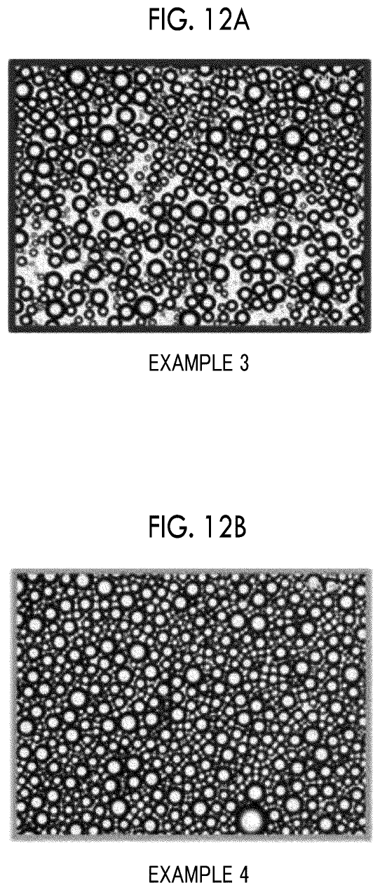

On the other hand, in Examples 3 and 4, the shearing force applied to the entire porous cylindrical tube was uniformized by forming the helical flow channel. Therefore, it was confirmed that in a case where only the upstream region of the pipe-shaped SPG membrane as the porous cylindrical tube was used (Example 3) and in a case where the entire region was used (Example 4), the particle diameter was uniformized and as shown in FIGS. 12A and 12B, the CV value was also suppressed to 23% in a case where the entire region was used.

### [Particle Diameter Measurement and Calculation Method]

The average particle diameter of the liquid droplet, the air bubble, or the like is measured by observing the granular body with a transmission optical microscope.

As the transmission optical microscope, it is possible to use, for example, an inverted microscope Axio Observer. Z1 or the like.

Hereinafter, a measurement procedure for the average particle diameter of the liquid droplet will be described.

The liquid droplets dispersed in the continuous phase were placed on a 60 mmΦ polystyrene petri dish. In this case, the collected liquid droplets are not overlapped in a depth direction of the petri dish. The liquid droplets collected in the petri dish are observed with a transmission optical microscope, and imaged at an objective magnification of 5 times. 200 or more images of liquid droplets included in a screen obtained by the imaging are selected. The equivalent circle diameter of the liquid droplets (a diameter of a perfect circle corresponding to the area of the image of the granular body) is calculated using image processing software (for example, ImageJ). An arithmetic mean value of the calculated equivalent circle diameters of the liquid droplets is calculated, and defined as the average particle diameter of the liquid droplets.

The CV value of the particle diameter is a value obtained according to the following expression.

$$Expression : CV value ( \% ) of particle diameter = ( standard deviation of equivalent circle diameter of granular body / average particle diameter of granular body ) \times 100$$

Here, the average particle diameter of the granular bodies is a value measured by the method described above.

In addition, the standard deviation of the equivalent circle diameter of the granular body is the standard deviation of the equivalent circle diameters of 200 granular bodies, which is calculated in the measurement of the average particle diameter of the granular bodies.

What is claimed is:

1. A liquid droplet or air bubble generation device comprising:
a cylindrical tube having a plurality of pores on a wall surface; and
a helical partition structure that is fixedly disposed inside the cylindrical tube and forms a helical flow channel in a longitudinal direction of the cylindrical tube,
wherein the helical flow channel makes two or more turns within the cylindrical tube.

2. The liquid droplet or air bubble generation device according to claim 1,
wherein the helical partition structure has a core rod that is concentric with the cylindrical tube.

3. The liquid droplet or air bubble generation device according to claim 1,
wherein a space volume obtained by subtracting a volume of the helical partition structure from a space volume in the cylindrical tube is 10% or more and 80% or less of the space volume in the cylindrical tube.

4. The liquid droplet or air bubble generation device according to claim 1,
wherein a helical pitch of the helical partition structure varies along the longitudinal direction of the cylindrical tube.

5. The liquid droplet or air bubble generation device according to claim 1,
wherein a clearance between a maximum outer diameter of the helical partition structure and an inner diameter of the cylindrical tube is 0.5 mm or less.

6. The liquid droplet or air bubble generation device according to claim 1,
wherein the cylindrical tube is a porous glass body.

7. The liquid droplet or air bubble generation device according to claim 1,
wherein the cylindrical tube is a porous body in which the pores having a diameter of 0.1 μm to 200 μm are formed in a metal pipe.

8. The liquid droplet or air bubble generation method using the liquid droplet or air bubble generation device according to claim 1, the generation method comprising:
in a case where a liquid or a gas passes through the plurality of pores and enters the cylindrical tube, generating liquid droplets or air bubbles of the liquid or the gas that has entered the cylindrical tube, by a shearing force of a continuous phase flowing through the helical flow channel in the cylindrical tube.
